(19) United States
(12) Patent Application Publication
(10) Pub. No.: US 2007/0242158 A1
(43) Pub. Date: Oct. 18, 2007

(54) Apparatus and Method for Processing Signals in a Multi-Channel Receiver

(76) Inventor: Michael Anthony Pugel, Noblesville, IN (US)

Correspondence Address: JOSEPH J. LAKS, VICE PRESIDENT;THOMSON LICENSING LLC, PATENT OPERATIONS, PO BOX 5312, PRINCETON, NJ, 08543-5312, US

(21) Appl. No.: 11/628,542

(22) PCT Filed: Jun. 8, 2004
(86) PCT No.: PCT/US04/18087

§ 371 Date: Dec. 4, 2006

(51) Int. Cl. H04N 3/27

(52) U.S. Cl. 348/554; 348/E03.049

(57) ABSTRACT

Signal processing apparatus suitable for performing front-end signal processing in a multi-channel receiving device such as a multi-channel television signal receiver utilizes a cost-effective and scaleable architecture. According to an exemplary embodiment, the signal processing apparatus includes an RF signal source operative to generate first and second RF signals responsive to user channel selection. A first IF generator is operative to generate a first IF signal corresponding to the first RF signal responsive to the user channel selection. A second IF generator is operative to generate a second IF signal corresponding to the second RF signal responsive to the user channel selection. The first IF signal exhibits a predetermined frequency relationship relative to the second IF signal

The present invention generally relates to signal processing in a multi-channel receiving device such as a multi-channel television signal receiver, and more particularly, to an apparatus and method for performing signal processing in a multi-channel receiving device that utilizes a cost-effective and scaleable architecture.

Devices such as television signal receivers may be designed to provide either single or multiple channel reception capability. With certain applications, single channel reception capability may be sufficient. For example, if cost is a paramount issue for a particular signal receiver application, it may be desirable to provide only single channel reception capability. Alternatively, there may be signal receiver applications in which multiple channel reception capability is desired. For example, multiple channel reception capability may be desirable so that multiple broadcast channels can be received simultaneously. This functionality may, for example, enable consumers to watch one channel and record another channel at the same time.

Current multi-channel receiving devices often have architectures with dedicated processing components for each received channel. For example, certain devices may include a dedicated tuner, analog-to-digital (A/D) converter, demodulator and/or other components for each received channel. Devices having such architectures tend to be costly to produce since dedicated components are required for each received channel, and little component sharing (if any) is employed. The relatively high cost of production in turn causes such devices to be more expensive for consumers.

Accordingly, there is a need for an apparatus and method for performing signal processing in a multi-channel receiving device such as a multi-channel television signal receiver that utilizes a cost-effective, yet scaleable, architecture. The present invention addresses these and/or other issues.

In accordance with an aspect of the present invention, signal processing apparatus is disclosed. According to an exemplary embodiment, the signal processing apparatus comprises an RF signal source for generating first and second RF signals responsive to user channel selection. First IF generating means generates a first IF signal corresponding to the first RF signal responsive to the user channel selection. Second IF generating means generates a second IF signal corresponding to the second RF signal responsive to the user channel selection. The first IF signal exhibits a predetermined frequency relationship relative to the second IF signal

In accordance with another aspect of the present invention, a method for performing signal processing in a multi-channel receiver is disclosed. According to an exemplary embodiment, the method comprises steps of generating first and second RF signals responsive to user channel selection, generating a first IF signal corresponding to the first RF signal responsive to the user channel selection, generating a second IF signal corresponding to the second RF signal responsive to the user channel selection, and wherein the first IF signal exhibits a predetermined frequency relationship relative to the second IF signal.

In accordance with another aspect of the present invention, a television signal receiver is disclosed. According to an exemplary embodiment, the television signal receiver comprises an RF signal source operative to generate first and second RF signals responsive to user channel selection. A first IF generator is operative to generate a first IF signal corresponding to the first RF signal responsive to the user channel selection. A second IF generator is operative to generate a second IF signal corresponding to the second RF signal responsive to the user channel selection. The first IF signal exhibits a predetermined frequency relationship relative to the second IF signal.

The above-mentioned and other features and advantages of this invention, and the manner of attaining them, will become more apparent and the invention will be better understood by reference to the following description of embodiments of the invention taken in conjunction with the accompanying drawings, wherein:

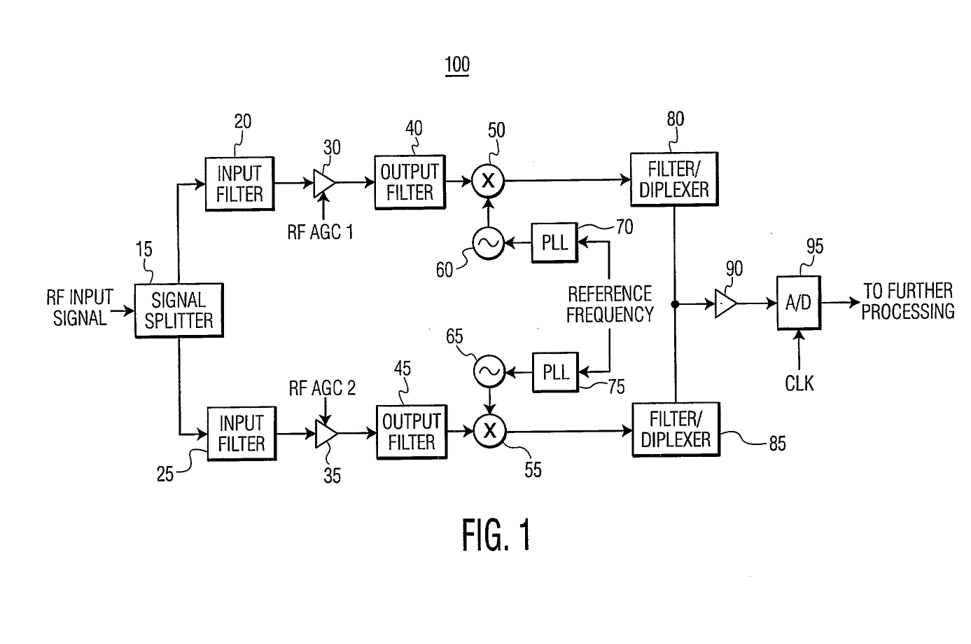

FIG. 1 is a block diagram of signal processing apparatus according to an exemplary embodiment of the present invention;

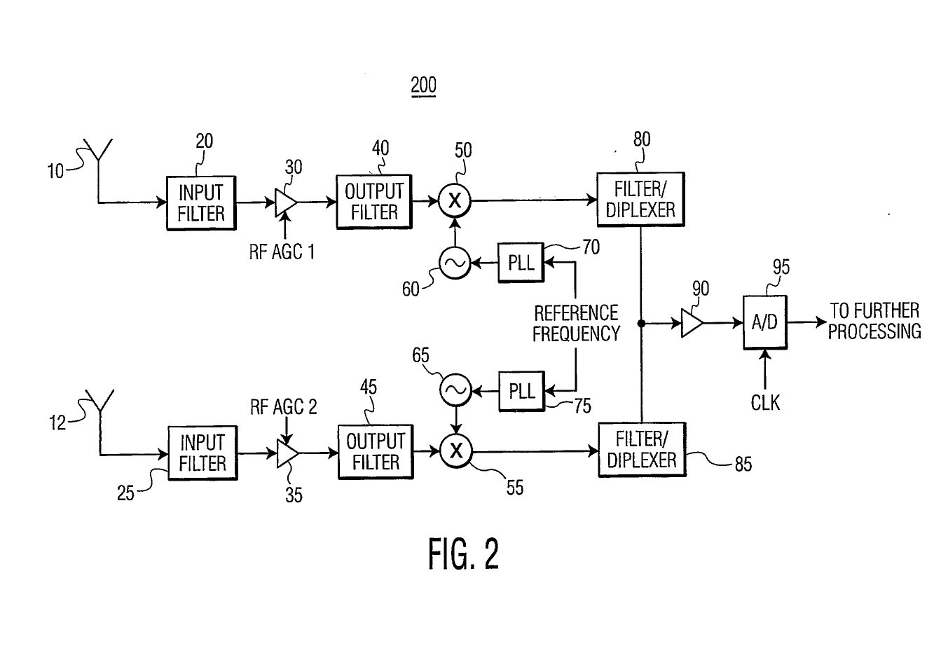

FIG. 2 is a block diagram of signal processing apparatus according to another exemplary embodiment of the present invention; and

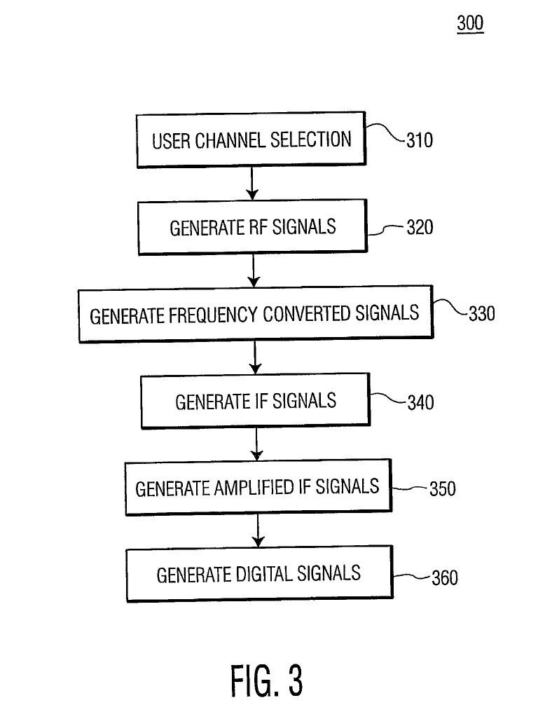

FIG. 3 is a flowchart illustrating steps according to an exemplary embodiment of the present invention.

The exemplifications set out herein illustrate preferred embodiments of the invention, and such exemplifications are not to be construed as limiting the scope of the invention in any manner. Common reference numbers are used to represent the same or similar elements throughout the drawings.

Referring now to the drawings, and more particularly to FIG. 1, signal processing apparatus 100 according to an exemplary embodiment of the present invention is shown. Signal processing apparatus 100 may for example represent the front-end processing circuitry of a multi-channel receiving device such as multi-channel television signal receiver and/or other device. As shown in FIG. 1, signal processing apparatus 100 comprises a radio frequency (RF) signal source such as signal splitter 15, input filters 20 and 25, automatic gain control (AGC) amplifiers 30 and 35, and output filters 40 and 45, intermediate frequency (IF) generating means such as signal mixers 50 and 55, local oscillators (LOs) 60 and 65, phase locked loops (PLLs) 70 and 75, and filters/diplexers 80 and 85, signal amplifying means such as amplifier 90, and A/D converting means such as A/D converter 95. Many of the foregoing elements of FIG. 1 may be embodied using integrated circuits (ICs), and some elements may for example be included on one or more ICs. For clarity of description, certain conventional elements associated with signal processing apparatus 100 such as certain control signals, power signals and/or other elements may not be shown in FIG. 1.

Signal splitter 15 is operative to receive a radio frequency (RF) input signal and to split the received RF signal into a plurality of RF signals that include substantially the same content as the received RF input signal. According to an exemplary embodiment, the RF input signal received by signal splitter 15 may include audio, video and/or data content and be provided from one or more signal sources such as terrestrial, cable, satellite, internet and/or other signal sources.

For purposes of example and explanation, signal processing apparatus 100 of FIG. 1 shows the RF input signal being split by signal splitter 15 into two RF signals that are each processed separately in a different processing path. According to the present invention, each processing path performs signal processing for a single channel. In particular, in FIG. 1, input filter 20, AGC amplifier 30, output filter 40, signal mixer 50, LO 60, PLL 70, and filter/diplexer 80 represent a first processing path that performs signal processing for a first channel. Similarly, input filter 25, AGC amplifier 35, output filter 45, signal mixer 55, LO 65, PLL 75, and filter/diplexer 85 represent a second processing path that performs signal processing for a second channel. However, according to principles of the present invention, the RF input signal may also be split into more than two RF signals. Accordingly, the architecture of signal processing apparatus 100 is scaleable, and may be modified to include a number of different processing paths corresponding to the number of RF signals provided by signal splitter 15. In this manner, signal processing apparatus 100 may include N different processing paths to perform signal processing for N channels.

Input filters 20 and 25 are operative to filter the RF signals provided from signal splitter 15 to thereby generate a first set of filtered RF signals responsive to user channel selection. AGC amplifiers 30 and 35 are operative to amplify the filtered RF signals provided from input filters 20 and 25 responsive to gain control signals RF AGC 1 and RF AGC 2, respectively, to thereby generate gain controlled RF signals. Output filters 40 and 45 are operative to filter the gain controlled RF signals provided from AGC amplifiers 30 and 35 to thereby generate a second set of filtered RF signals responsive to user channel selection. In general, the filtering operations of input filters 20 and 25 and output filters 40 and 45 isolate signals responsive to user channel selection and prevent undesired signals from interfering with desired signals within the selected channel(s). However, depending on the design of signal processing apparatus 100, input filters 20 and 25 and output filters 40 and 45 may be optional elements. In the aforementioned manner, signal splitter 15, input filters 20 and 25, AGC amplifiers 30 and 35, and output filters 40 and 45 generate RF signals responsive to user channel selection.

Signal mixers 50 and 55 are operative to mix the filtered RF signals provided from output filters 40 and 45 with LO signals provided from LOs 60 and 65, respectively, to thereby generate frequency converted signals. LOs 60 and 65 are operative to generate the LO signals used by signal mixers 50 and 55 responsive to PLL signals provided from PLLs 70 and 75, respectively, and user channel selection. PLLs 70 and 75 are operative to generate the PLL signals used by LOs 60 and 65, respectively, responsive to a reference frequency. In the aforementioned manner, signal mixer 50, LO 60, and PLL 70 operate as a first tuning means, and signal mixer 55, LO 65, and PLL 75 operate as a second tuning means. As will be described later herein, these first and second tuning means operate independently from one another, and may perform frequency upconversion or downconversion operations.

Filters/diplexers 80 and 85 are operative to filter and diplex the frequency converted signals provided from signal mixers 50 and 55, respectively, to thereby generate IF signals. According to an exemplary embodiment, filters/diplexers 80 and 85 filter the frequency converted signals such that the resultant IF signals are positioned adjacent to one another in frequency with a guard band in between. Each IF signal may for example include a plurality of virtual or sub-channels. Further details regarding this aspect of the present invention will be provided later herein.

Amplifier 90 is operative to amplify the IF signals provided from filters/diplexers 80 and 85 to thereby generate amplified IF signals. According to an exemplary embodiment, the bandwidth occupied by the amplified IF signals provided from amplifier 90 depends upon the number of IF signals generated by signal processing apparatus 100.

A/D converter 95 is operative to convert the amplified IF signals provided from amplifier 90 to digital signals in accordance with a clock (CLK) signal. According to an exemplary embodiment, A/D converter 95 performs the equivalent of frequency conversion, and thereby operates in conjunction with signal mixers 50 and 55 to perform a two-stage frequency conversion. As indicated in FIG. 1, the digital signals generated by A/D converter 95 may be provided for further processing (e.g., demodulation, transport processing, decoding, etc.), and ultimately aural and/or visual output. Accordingly, signal processing apparatus 100 advantageously utilizes only a single A/D converter 95, and demodulator (not shown) for all received channels.

Referring to FIG. 2, signal processing apparatus 200 according to another exemplary embodiment of the present invention is shown. Like signal processing apparatus 100 of FIG. 1, signal processing apparatus 200 of FIG. 2 may also represent the front-end processing circuitry of a multi-channel receiving device such as multi-channel television signal receiver and/or other device. For purposes of example and explanation, signal processing apparatus 200 of FIG. 2 also includes two different processing paths for two channels, but is scaleable and may be modified to accommodate more than two channels. Signal processing apparatus 200 of FIG. 2 also includes many of the same elements as signal processing apparatus 100 of FIG. 1, and such common elements are represented by the same reference numbers in FIGS. 1 and 2. For clarity of description, these common elements will not be described again, and the reader may refer to the description of these elements previously provided herein. However, signal processing apparatus 200 of FIG. 2 differs from signal processing apparatus 100 of FIG. 1 in that it includes a first antenna 10 and a second antenna 12, instead of signal splitter 15. The exemplary embodiment of signal processing apparatus 200 shown in FIG. 2 may for example be used to receive a plurality of terrestrial broadcast channels simultaneously.

To facilitate a better understanding of the present invention, an example will now be provided. Referring to FIG. 3, a flowchart 300 illustrating steps according to an exemplary embodiment of the present invention is shown. For purposes of example and explanation, the steps of FIG. 3 will be described with reference to the elements of signal processing apparatus 100 and 200 shown in FIGS. 1 and 2. The steps of FIG. 3 are merely exemplary, and are not intended to limit the present invention in any manner.

At step 310, user channel selection for signal processing apparatus 100/200 is performed. According to an exemplary embodiment, a user may perform channel selection at step 310 by making one or more inputs to signal processing apparatus 100/200 via a user input device (not shown in FIGS. 1 and 2), such as a hand-held remote control device, wired and/or wireless keyboard, keypad, and/or other input device/element. With the exemplary embodiments shown in FIGS. 1 and 2, the user may select up to two different channels at step 310, and may for example enable a picture-in-picture (PIP) function, a recording function (e.g., watch one channel while recording another), and/or other functions. However, as previously indicated herein, signal processing apparatus 100/200 is scaleable and may be modified so that more than two channels can be selected at step 310.

At step 320, signal processing apparatus 100/200 generates RF signals responsive to the user channel selection of step 310. According to exemplary embodiments, input filter 20, AGC amplifier 30, and output filter 40 process an RF input signal provided from signal splitter 15 (embodiment of FIG. 1) or first antenna 10 (embodiment of FIG. 2) to generate a first RF signal corresponding to a first channel at step 320 responsive to the user channel selection of step 310. Similarly, input filter 25, AGC amplifier 35, and output filter 45 process an RF input signal provided from signal splitter 15 (embodiment of FIG. 1) or second antenna 12 (embodiment of FIG. 2) to generate a second RF signal corresponding to a second channel at step 320 responsive to the user channel selection of step 310. Accordingly, the first and second RF signals exhibit a frequency relationship based on the user channel selection at step 310. As will described later herein, the first and second channels may be different channels, or the same channel. The RF input signals may include audio, video and/or data content and may be provided from the same signal source, or from different signal sources, such as terrestrial, cable, satellite, internet and/or other signal sources. The bandwidth of the RF input signals may vary depending upon the signal source. According to an exemplary embodiment, the RF input signals may include a plurality of 6 MHz physical channels, and each such physical channel may include a plurality of virtual or sub-channels.

At step 330, signal processing apparatus 100/200 generates frequency converted signals from the RF signals generated at step 320. According to an exemplary embodiment, signal mixer 50, LO 60, and PLL 70 operate as a first tuning means to generate a first frequency converted signal, and signal mixer 55, LO 65, and PLL 75 operate as a second tuning means to generate a second frequency converted signal at step 330.

As an example, assume that a user has selected two different channels at step 310, namely channel 7 having a center frequency of 177 MHz and channel 13 having a center frequency of 213 MHz. Each channel has a 6 MHz bandwidth. Signal mixers 50 and 55 receive the 177 MHz and 213 MHz signals from output filters 40 and 45, and mix the received signals with LO signals provided from LOs 60 and 65 to generate the first and second frequency converted signals, respectively, at step 330. According to this example, LO 60 provides an LO signal having a frequency of 1097 MHz and LO 65 provides an LO signal having a frequency of 1153 MHz. Signal mixer 50 mixes the 177 MHz signal provided from output filter 40 with the 1097 MHz signal provided from LO 60 to thereby generate the first frequency converted signal having a center frequency of 920 MHz. Signal mixer 55 mixes the 213 MHz signal provided from output filter 45 with the 1153 MHz signal provided from LO 65 to thereby generate the second frequency converted signal having a center frequency of 940 MHz. In this example, frequency upconversions were performed on the 177 MHz and 213 MHz signals. However, frequency downconversions may also be performed according to the present invention. According to an exemplary embodiment, the 177 MHz and 213 MHz signals are frequency upconverted to 920 MHz and 940 MHz, respectively, to facilitate an IF stacking arrangement according to the present invention which will be described in more detail later herein.

As another example, assume that a user has selected only one channel at step 310, namely channel 13 having a center frequency of 213 MHz, and a 6 MHz bandwidth. In this case, input filters 20 and 25 and output filters 40 and 45 provide the same 213 MHz signal responsive to the user channel selection of step 310. To facilitate the IF stacking arrangement of the present invention, LOs 60 and 65 provide LO signals of different frequencies. According to this example, LO 60 provides an LO signal having a frequency of 1133 MHz and LO 65 provides an LO signal having a frequency of 1153 MHz. Signal mixer 50 mixes the 213 MHz signal provided from output filter 40 with the 1133 MHz signal provided from LO 60 to thereby generate the first frequency converted signal having a center frequency of 920 MHz. Signal mixer 55 mixes the 213 MHz signal provided from output filter 45 with the 1153 MHz signal provided from LO 65 to thereby generate the second frequency converted signal having a center frequency of 940 MHz. It is noted that when the user has selected only one channel at step 310, some phase compensation may be required.

At step 340, signal processing apparatus 100/200 generates IF signals from the frequency converted signals generated at step 330. According to an exemplary embodiment, filters/diplexers 80 and 85 filter the first and second frequency converted signals provided from signal mixers 50 and 55 to thereby generate first and second IF signals, respectively, in a fixed frequency stacked arrangement. According to the previous example, filter/diplexer 80 may provide a 6 MHz pass band for the 920 MHz signal to thereby generate the first IF signal from 917 MHz to 923 MHz. Filter/diplexer 85 may also provide a 6 MHz pass band for the 940 MHz signal to thereby generate the second IF signal from 937 MHz to 943 MHz. With this example, a guard band would exist between 923 MHz to 937 MHz. In this manner, filter/diplexer 80 generates a first IF signal that occupies a first frequency band (e.g., 917 MHz to 923 MHz), filter/diplexer 85 generates a second IF signal that occupies a second frequency band (e.g., 937 MHz to 943 MHz), and a guard band (e.g., 923 MHz to 937 MHz) exists between and is contiguous with the first and second frequency bands. Accordingly, the first and second IF signals generated at step 340 are frequency-stacked with a guard band in between. If the architecture of signal processing apparatus 100/200 is expanded, more than two frequency-stacked IF signals may be generated at step 340 according to the present invention. It is noted that the frequency relationship between the first and second RF signals generated at step 320 is governed by the user channel selection at step 310, and is therefore independent of the predetermined, frequency-stacked relationship between the first and second IF signals generated at step 340.

At step 350, signal processing apparatus 100/200 generates amplified IF signals from the IF signals generated at step 340. According to an exemplary embodiment, amplifier 90 amplifies the IF signals provided from filters/diplexers 80 and 85 to thereby generate amplified IF signals. The bandwidth occupied by the amplified IF signals provided from amplifier 90 depends upon the number of IF signals generated by signal processing apparatus 100. According to the previous example, the amplified IF signals provided from amplifier 90 have a 26 MHz bandwidth from 917 MHz to 943 MHz, wherein 923 MHz to 937 MHz represents a guard band. Of course, all of the frequencies and frequency bands referred to herein are exemplary only, and other frequencies and/or frequency bands may also be used according to the present invention.

At step 360, signal processing apparatus 100/200 generates digital signals from the amplified IF signals generated at step 350. According to an exemplary embodiment, A/D converter 95 converts the amplified IF signals provided from amplifier 90 to digital signals in accordance with the clock (CLK) signal. According to the previous example, the clock (CLK) signal must exhibit a frequency above 52 MHz to satisfy Nyquist criterion for the 26 MHz bandwidth composite IF signal. For example, clock frequencies of 53.9 MHz or 63 MHz may be used. A/D converter 95 performs the equivalent of frequency conversion, and thereby operates in conjunction with signal mixers 50 and 55 to perform a two-stage frequency conversion. According to the present invention, the digital signals generated by A/D converter 95 may be provided for further processing (e.g., demodulation, transport processing, decoding, etc.), and ultimately aural and/or visual output.

As described herein, the present invention provides an apparatus and method 30 for performing signal processing in a multi-channel receiving device such as a multi-channel television signal receiver that utilizes a cost-effective and scaleable architecture. The present invention may be applicable to various apparatuses, either with or without a display device. Accordingly, the phrases “signal processing apparatus” or “television signal receiver” as used herein may refer to systems or apparatuses including, but not limited to, television sets, computers or monitors that include a display device, and systems or apparatuses such as set-top boxes, video cassette recorders (VCRs), digital versatile disk (DVD) players, video game boxes, personal video recorders (PVRs), computers or other apparatuses that may not include a display device. The present invention may also be applicable to applications such as cellular and/or wireless telephone applications. For example, the signal processing apparatuses disclosed herein could be used for cellular telephone base stations and/or other applications.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. Signal processing apparatus comprising:
an RF signal source for generating first and second RF signals responsive to user channel selection;
first IF generating means for generating a first IF signal corresponding to said first RF signal responsive to said user channel selection;
second IF generating means for generating a second IF signal corresponding to said second RF signal responsive to said user channel selection; and
wherein said first IF signal exhibits a predetermined frequency relationship relative to said second IF signal.

2. The signal processing apparatus of claim 1, wherein said RF signal source comprises a signal splitter for splitting a received RF signal to enable generation of said first and second RF signals.

3. The signal processing apparatus of claim 1, wherein said RF signal source comprises:
a first antenna for receiving a first signal corresponding to said first RF signal; and
a second antenna for receiving a second signal corresponding to said second RF signal.

4. The signal processing apparatus of claim 1, wherein:
said first IF signal occupies a first frequency band;
said second IF signal occupies a second frequency band; and
a guard band exists between and is contiguous with said first and second frequency bands.

5. The signal processing apparatus of claim 1, wherein said first IF generating means includes:
first tuning means for frequency upconverting said first RF signal to generate a first frequency converted signal; and
first filtering means for filtering said first frequency converted signal to generate said first IF signal.

6. The signal processing apparatus of claim 5, wherein said second IF generating means includes:
second tuning means for frequency upconverting said second RF signal to generate a second frequency converted signal; and
second filtering means for filtering said second frequency converted signal to generate said second IF signal.

7. The signal processing apparatus of claim 1, wherein said first IF generating means includes:
first tuning means for frequency downconverting said first RF signal to generate a first frequency converted signal; and
first filtering means for filtering said first frequency converted signal to generate said first IF signal.

8. The signal processing apparatus of claim 7, wherein said second IF generating means includes:
second tuning means for frequency downconverting said second RF signal to generate a second frequency converted signal; and
second filtering means for filtering said second frequency converted signal to generate said second IF signal.

9. The signal processing apparatus of claim 1, further comprising A/D converting means for generating digital signals corresponding to said first and second IF signals.

10. The signal processing apparatus of claim 1, wherein:
said first and second RF signals exhibit a frequency relationship based on said user channel selection; and
said frequency relationship between said first and second RF signals is independent of said predetermined frequency relationship between said first and second IF signals.

11. A method for performing signal processing in a multi-channel receiver, comprising:
generating first and second RF signals responsive to user channel selection;
generating a first IF signal corresponding to said first RF signal responsive to said user channel selection;
generating a second IF signal corresponding to said second RF signal responsive to said user channel selection; and
wherein said first IF signal exhibits a predetermined frequency relationship relative to said second IF signal.

12. The method of claim 11, further comprised of splitting a received RF signal to enable generation of said first and second RF signals.

13. The method of claim 11, further comprised of:
receiving a first signal corresponding to said first RF signal via a first antenna; and
receiving a second signal corresponding to said second RF signal via a second antenna.

14. The method of claim 11, wherein:
said first IF signal occupies a first frequency band;
said second IF signal occupies a second frequency band; and
a guard band exists between and is contiguous with said first and second frequency bands.

15. The method of claim 11, wherein said step of generating said first IF signal includes:
frequency upconverting said first RF signal to generate a first frequency converted signal; and
filtering said first frequency converted signal to generate said first IF signal.

16. The method of claim 15, wherein said step of generating said second IF signal includes:
frequency upconverting said second RF signal to generate a second frequency converted signal; and
filtering said second frequency converted signal to generate said second IF signal.

17. The method of claim 11, wherein said step of generating said first IF signal includes:
frequency downconverting said first RF signal to generate a first frequency converted signal; and
filtering said first frequency converted signal to generate said first IF signal.

18. The method of claim 17, wherein said step of generating said second IF signal includes:
frequency downconverting said second RF signal to generate a second frequency converted signal; and
filtering said second frequency converted signal to generate said second IF signal

19. The method of claim 11, further comprised of generating digital signals corresponding to said first and second IF signals.

20. The method of claim 11, wherein:
said first and second RF signals exhibit a frequency relationship based on said user channel selection; and
said frequency relationship between said first and second RF signals is independent of said predetermined frequency relationship between said first and second IF signals.

21. A television signal receiver, comprising:
an RF signal source operative to generate first and second RF signals responsive to user channel selection;
a first IF generator operative to generate a first IF signal corresponding to said first RF signal responsive to said user channel selection;
a second IF generator operative to generate a second IF signal corresponding to said second RF signal responsive to said user channel selection; and
wherein said first IF signal exhibits a predetermined frequency relationship relative to said second IF signal.

22. The television signal receiver of claim 21, wherein said RF signal source comprises a signal splitter for splitting a received RF signal to enable generation of said first and second RF signals.

23. The television signal receiver of claim 21, wherein said RF signal source comprises:
a first antenna for receiving a first signal corresponding to said first RF signal; and
a second antenna for receiving a second signal corresponding to said second RF signal.

24. The television signal receiver of claim 21, wherein:
said first IF signal occupies a first frequency band;
said second IF signal occupies a second frequency band; and
a guard band exists between and is contiguous with said first and second frequency bands.

25. The television signal receiver of claim 21, wherein said first IF generator includes:
a first tuner operative to frequency upconvert said first RF signal to generate a first frequency converted signal; and
a first filter operative to filter said first frequency converted signal to generate said first IF signal.

26. The television signal receiver of claim 25, wherein said second IF generator includes:
a second tuner operative to frequency upconvert said second RF signal to generate a second frequency converted signal; and
a second filter operative to filter said second frequency converted signal to generate said second IF signal.

27. The television signal receiver of claim 21, wherein said first IF generator includes:
a first tuner operative to frequency downconvert said first RF signal to generate a first frequency converted signal; and
a first filter operative to filter said first frequency converted signal to generate said first IF signal.

28. The television signal receiver of claim 27, wherein said second IF generator includes:
a second tuner operative to frequency downconvert said second RF signal to generate a second frequency converted signal; and
a second filter operative to filter said second frequency converted signal to generate said second IF signal.

29. The television signal receiver of claim 21, further comprising an A/D converter operative to generate digital signals corresponding to said first and second IF signals.

30. The television signal receiver of claim 21, wherein:
said first and second RF signals exhibit a frequency relationship based on said user channel selection; and
said frequency relationship between said first and second RF signals is independent of said predetermined frequency relationship between said first and second IF signals.
